(19) United States
(12) Patent Application Publication
(10) Pub. No.: US 2002/0017133 A1
(43) Pub. Date: Feb. 14, 2002

(54) Surface/bulk micromachined single-crystalline silicon micro-gyroscope

(76) Inventor: Dong-il Cho, Seoul (KR)

Correspondence Address: Paul H. Johnson, Head, Johnson & Kachigian, 228 West 17th Place, Tulsa, OK, 74119, US

(21) Appl. No.: 09/903,280

(22) Filed: Jul. 11, 2001

(30) Foreign Application Priority Data
Jul. 13, 2000 (KR) 2000-40121

(51) Int. Cl. G01C 19/00; G01P 15/14

(52) U.S. Cl. 73/504.02; 73/504.08; 73/504.18

(57) ABSTRACT

A micromachined single-crystalline silicon micro-gyroscope comprising oxide/polysilicon/metal triple layer for electrical isolation is disclosed. The isolation method includes forming the triple layer composed of an insulation layer formed over an exposed surface of the silicon microstructure, a conductive layer formed over the entire insulation layer, and a metal layer formed over a top portion of the microstructure; and partially etching the conductive layer to form electrical isolation between parts of the microstructure. The method does not require a separate photolithography process for isolation, and can be effectively applied to microstructures having high aspect ratios and narrow trenches. Also disclosed are micro-gyroscope comprising a new type of spring which has a node with a hole in the middle of spring to reduce the release etch time for spring.

### BACKGROUND OF THE INVENTION

1. Field of the Invention

The present invention relates to micro-gyroscope in particular to surface/bulk micromachined single-crystalline silicon micro-gyroscopes.

2. Description of the Related Art

Microelectromechanical systems include component structures with typical minimum dimensions on the order of a micron where the component structures can have elaborate shapes and perform a variety of complex functions. The component structures of microelectromechanical systems are formed on a semiconductor or glass substrate. Microelectromechanical systems include devices such as accelerometers that sense the acceleration of a moving object, gyroscopes that sense the angular rate of a rotating object and mirror arrays that deflect light in fiber optic communication and display applications. Micromachining techniques are used to fabricate the very small structures that are integrated with electrical parts on the semiconductor or glass substrate. The techniques used to fabricate these microelectromechanical systems are largely based on semiconductor device fabricating technology, including photolithography, thin film deposition, etching, impurity doping by diffusion and ion implantation, electroplating and wafer bonding.

Micro-gyroscopes for measuring the rate and/or angle of rotation have received much attention. Application areas include navigation systems, automotive safety and stability control systems, video camera stabilization, and 3-D input devices for computers and personal data assistance (PDA) systems.

Gyroscope measures the rate and/or angle of rotation by a Coriolis force which is generated at from a vibrating part. Structure of a gyroscope basically has a mass for driving the vibrating part and a mass for sensing the motion generated by the Coriolis force, which are respectively supported by springs. These springs should be aligned with each other at a 90° angle. A micro-gyroscope includes electrodes that are electrically isolated to allow, for example, to measure electrical signals flowing in the sensing part of the system. Other example of electrodes are used to apply electrical signals to the vibrating parts of the system. Groscopes with separate sets of suspensions for the driving and sensing mode are called “decoupled” gyroscope. It is well known that the resolution of a coupled gyroscope is relatively lower than that of a decoupled gyroscope, because of the cross-axis mode coupling.

Firstly, conventional various micro-gyroscopes are explained as follows.

Researchers at the Charles Stark Draper Laboratory demonstrated one of the first silicon gyroscopes in 1991, using the p++ etch stop technique, and a resolution of 4°/sec was achieved with a 1 Hz bandwidth as discussed in P. Greiff, B. Boxenhom, T. King, and L. Niles, “Silicon monolithic micromechanical gyroscope,” in Tech. Dig. 6th Int. Conf. Solid-State Sensors and Actuators (Transducers '91), San Francisco, Calif., June 1991, pp. 966-968. In 1996, researchers at Berkeley reported a surface micromachined polysilicon gyroscope integrated with a transresistance amplifier on a single die as discussed in W. A. Clark, R. T. Howe, and R. Horowitz, “Surface micromachined z-axis vibratory rate gyroscope,” in Tech. Dig. Solid-State Sensor & Actuator Workshop, Hilton Head Island, S.C., June 1996, pp. 299-302. This device was fabricated by the Analog Devices BiMEMS process, and showed a resolution of 1°/sec with a 1 Hz bandwidth.

To achieve an improved resolution, increasing the thickness of structures and using single-crystalline silicon as a structural material have been an active research topic in more recent years. High-aspect-ratio structures (HARS) provide a large lateral capacitance, which in turn, allows realizing high-sensitivity sensors or high-force actuators. Furthermore, a reduced cross-axis coupling is possible with HARS. Since the availability of deep silicon etchers, many process techniques for fabricating HARS have been developed as discussed in K. A. Shaw, Z. L. Zhang, and N. C. MacDonald, “SCREAM I: a single mask, single-crystal silicon, reactive ion etching process for microelectromechanical structures,” Sensors and Actuators A, vol. 40, pp. 63-70, 1994. Other HARS fabrication methods are discussed in J. Muchow, H. Muenzel, M. Offenberg, W. Waldvogel, “Method of fabricating a micromechanical sensor,” U.S. Pat. No. 5, 616, 514, Apr. 1997 and B. Diem, M. T. Delaye, F. Michel, S. Renard, and G. Delapoerre, “SOI(SIMOX) as a substrate for surface micromachining of single crystalline silicon sensors and actuators,” in Tech. Dig. 7th Int. Conf Solid-State Sensors and Actuators (Transducers'93), Yokohama, Japan, June 1993, pp. 233-236.

In 1997, researchers at HSG-IMIT reported a 10 □-thick, x-axis gyroscope using epitaxially-grown polysilicon as a structural material as discussed in W. Geiger, B. Folkmer, J. Merz, H. Sandmaier, and W. Lang, “A new silicon rate gyroscope,” in Proc. IEEE Workshop on Microelectromech. Syst. (MEMS'98), Heidelberg, Germany, February 1998, pp. 615-620. The device showed a 0.096% sec resolution with a 50 Hz bandwidth. Researchers at Samsung also reported a gyroscope using the SOI(Silicon on Insulator) process which showed a resolution of 0.015% sec with a 25 Hz bandwidth as discussed in K. Y. Park, H. S. Jeong, S. An, S. H. Shin, and C. W. Lee, “Lateral gyroscope suspended by two gimbals through high aspect ratio ICP etching,” in Tech. Dig. 10th Int. Conf Solid-State Sensors and Actuators (Transducers'99), Sendai, Japan, June 1999, pp. 972-975 and an other gyroscope using an anodically bonded wafer which showed a resolution of 0.01°/sec at a 5 Hz angular-rate input as discussed in S. S. Baek, Y. S. Oh, B. J. Ha, S. D. An, B. H. An, H. Song, and C. M. Song, “A symmetrical z-axis gyroscope with a high aspect ratio using simple and new process,” in Proc. IEEE Workshop on Microelectromech. Syst. (MEMS'99), Orlando, Fla., Jan. 1999, pp. 612-617.

The epi-poly process utilizes a polycrystalline-phase film for the structural material, and similar to the LPCVD polysilicon films, it can have problems of residual stress or stress gradient. In the SOI process, the structural material is single-crystalline silicon, but the high cost of wafers and the residual stress resulting from the bonding process are the main disadvantages. Furthermore, the sacrificial gap thickness is limited by the buried oxide layer thickness. Another major drawback of the SOI and epi-poly processes is the footing effect. An uncontrollable undercutting phenomenon occurs at the boundary between silicon and oxide layer in deep RIE processes. The footing effect can significantly alter the stiffness properties and reduce reproducibility.

As a new alternative of silicon HARS micromachining techniques, D. Cho et al. have developed the single-wafer Surface/Bulk Micromachining (SBM) technology as discussed in S. Lee, S. Park, and D. Cho, “A new micromachining technique with (111) silicon,” Japanese Journal of Applied Physics, vol. 38, pp. 2699-2703, May 1999; S. Park, S. Lee, S. Yi, and D. Cho, “Mesa-supported, single-crystal microstructures fabricated by the surface/bulk micromachining (SBM) process”, Japanese Journal of Applied Physics, vol. 38, pp. 4244-4249, July 1999. S. Lee, S. Park, and D. Cho; “The surface/bulk micromachining (SBM) process: a new method for fabricating released microelectromechanical systems in single crystal silicon,” IEEE/ASME J. Microelctromech. Syst., vol. 8, no. 4, pp. 409-416, Dec. 1999; S. Lee, S. Park, and D. Cho, “Surface/bulk micromachining (SBM) process and deep trench oxide isolation method for MEMS,” in Tech. Dig. IEEE Electron Devices Meeting (IEDM'99), Washington, D.C., December 1999, pp. 701-704; and D. Cho, S. Lee, S. Park, “Micromachanical System Fabrication Method Using (111) Single Crystalline Silicon,” U.S. Pat. No. 6,150,275, November 2000. The SBM technology can fabricate released structures of single-crystalline silicon without using the intermediate oxide layer or wafer bonding. In addition, the footing phenomenon does not occur in this process.

Secondly, conventional isolation methods used in a micromechanical system are as follows.

FIG. 1 shows process steps in the conventional isolation process known as the single crystalline reactive etching and metallization (SCREAM) process. The SCREAM isolation process is performed on a structure fabricated by the SCREAM micromachining technique in the manner discussed in U.S. Pat. Nos. 5,563,343; 5,198,390; and K. A. Shaw, Z. L. Zhang, and N. C. MacDonald, “SCREAM I: A Single Mask, Single-Crystal Silicon, Reactive Ion Etching Process for Microelectromechanical Structures,” Sensors and Actuators A, Vol. 40, pp. 63, 1994. Plasma enhanced chemical vapor deposition (PECVD) covers all surfaces of a micromachined structure with an oxide film. Selective deposition of metal film on the structure forms electrodes and electrically conducting paths on top of the PECVD oxide film so that the PECVD oxide film separates the electrodes from the silicon substrate. In this SCREAM process, electrical isolation of the electrodes is achieved by depositing the metal film only on the top and the side surfaces of microelectromechanical structures that are covered by the PECVD oxide film.

The SCREAM isolation process has the advantage of being relatively simple in not requiring separate photolithography and etching steps once the structure is fabricated using the SCREAM micromachining technique. On the other hand, the coverage achieved in the deposition of the metal film is generally poor and hence the SCREAM isolation process typically cannot be applied. to tall structures having a high aspect ratio. It should be noted that, if a metal or other material is deposited that has good step coverage, such as metal films deposited by low pressure chemical vapor deposition (LPCVD), all electrodes and microelectromechanical parts are electrically connected, and hence, electrical isolation is not achieved.

FIG. 2 shows the silicon on oxide insulator (SOI) wafer method, used in forming the microelectromechanical systems described in the following references: B. Diem, et al., “SOI(SIMOX) as a Substrate for Surface Micromachining of Single Crystalline Silicon Sensors and Actuators,” Tech. Dig. 7th Int. Conf Solid-State Sensors and Actuators (Transducers '93), Yokohama, Japan, 1993, pp. 233-236; and C. Marxer, et al., “Vertical Mirrors Fabricated by Deep Reactive Ion Etching for Fiber-Optic Switching Applications,” IEEE/ASME Journal of Microelectromechanical Systems, Vol. 6, No. 3, pp. September 1997. In the SOI wafer method, the portion of the wafer on top of the buried oxide layer (device layer) is highly doped, conducting silicon. Since all structures and electrodes are fabricated in the device layer and are defined by etching the device layer down to the buried oxide layer, electrical isolation of the resulting electrodes is achieved automatically. On the other hand, SOI wafers are generally expensive and the residual stress created by the buried oxide layer can warp and change the shape of microelectromechanical structures made on the device layer. In addition, the micromachined portions of the device layer silicon near the oxide interface can have roughened features (produced by the “footing” effect) when the structures and electrodes are formed in a deep plasma etching process. Another disadvantage of the SOI process is that the as-manufactured wafer has an established thickness of the oxide film and the device layer and these thicknesses cannot be modified once a wafer is manufactured.

FIG. 3 shows a scanning electron microscope (SEM) photograph of a micromachined comb-drive structure fabricated from single crystal silicon. The electrodes of the illustrated comb-drive structure are isolated using the junction isolation method. The junction isolation method is described, for example, in S. Lee, S. Park and D. Cho, “The Surface/Bulk Micromachining (SBM) Process: A New Method for Fabricating Released Microelectromechanical Systems in Single Crystal Silicon,” IEEE/ASME J. Microelectromechanical Systems, Vol. 8, No. 4, December 1999. The junction isolation method forms a junction diode on a lightly doped N-type or P-type wafer. Applying a reverse biased voltage to the junction diode isolates the junction electrode from the substrate. Referring to FIG. 3, the silicon substrate is lightly doped P-type and the lighter parts, including the comb-drive structure, are highly doped N-type with phosphorus, so that a PN junction between the silicon substrate (P-type) and the electrode (N-type) is formed. In this case, if a reverse bias voltage is applied to the PN junction, the electrodes are electrically isolated from the silicon substrate. This method has the advantage that the isolation steps are done before the micromechanical structure is fabricated, so that the structure can be fabricated in a relatively easy manner and with relatively little of the stress created by the isolation method. On the other hand, the method has disadvantage that the depth of the PN junction often cannot be made sufficiently deep, so that this process usually is not readily applied to a tall structure having a high aspect ratio.

FIG. 4 is a structure formed by yet another conventional isolation method, the trench oxide isolation method, described in the following references: U.S. Pat. No. 5,930,595; U. Sridhar et al., “Trench Oxide Isolated Single Crystal Silicon Micromachined Accelerometer,” IEEE IEDM, San Francisco Calif., Dec. 6-9, 1998. pp. 475-478; and S. Lee, S. Park, D. Cho and Y. Oh “Surface/Bulk Micromachining (SBM) Process and Deep Trench Oxide Isolation Method for MEMS”, IEEE IEDM, Washington, D.C., December 5-8, 1999. pp.701-704. This trench isolation method includes forming U-shaped trenches 14 on a silicon substrate 16, forming thermal oxide layers 18 and depositing oxide layers 20 on all sides of the structure where the trenches are formed. The oxide films 18, 20 filling the trenches attach the electrode structures 22, 24 to the silicon substrate 16 through the respective sidewalls so that the oxide films support the electrodes and tethered structures. The oxide films electrically isolate the electrodes from each other and from the substrate.

This trench isolation method has the advantage that the method can be applied to a tall structure having a high aspect ratio. On the other hand, separate photolithography and etching steps are required to form a metal layer on the electrode to allow wire bonding the electrode to a package. Two different release processes are required: one to separate the electrode component from the substrate and a second to separate the structure part from the substrate. The trenches between the sidewalls of the electrode and the sidewalls of the substrate generally cannot be made arbitrarily large, as would be desired to achieve a small parasitic capacitance, without sacrificing the structural rigidity of the trench filled oxide layers that support the structure and electrodes. Additionally, the conventional trench isolation method deposits the insulation layers on the sides of the electrode to support the structure and electrodes. Therefore, the electrode and the substrate need to be supported by means other than the insulating layers during manufacturing, which limits the electrode shapes that can be made. In particular, it is difficult to fabricate an electrode in an “island” shape or in a complicated electrode arrangement like that used in a micro-gyroscope. Those skilled in the art can appreciate the need for a simpler isolation method.

FIG. 5 illustrates aspects of a surface/bulk micromachining technique, as described in co-pending U.S. patent application Ser. No. 09/756,981, filed Jan. 9, 2001 and entitled “Isolation Micromachined Single Crystal Using Deep Trench Insulation,” which patent application is hereby incorporated by reference in its entirety. This application describes an alternate strategy for electrically isolating microstructures. It should be noted that the present triple layer isolation can be used in conjunction with the isolation strategy described in the above-referenced surface/bulk micromachining application.

FIG. 5 shows an isolation process employing a deep trench insulation layer. First, a trench deeper than the thickness of the electrode to be formed is etched at an intermediate position of the electrode to be formed on a single crystalline silicon substrate. The trench is filled with an insulation material such as silicon oxide. The moving structure and the electrode portion 51 are then released and separated from the silicon substrate. As shown in FIG. 5, the oxide or other insulation is stripped from the surface of the silicon workpiece. The process then forms a mask on the surface of the workpiece establishing the lateral extents of the electrodes to be formed. Deep etching proceeds deeper than the height of the electrode. The sidewalls of the electrode are passivated and then the trenches are etched deeper to expose sidewalls beneath the electrodes. Lateral release etching is conducted to form the electrode structures. Finally, metal is sputtered over the electrodes to make them more conductive so that contacts can readily be formed.

The insulation layer 52 filled in the deep trench is fixed in the silicon substrate and supports the electrode portion from the interior of the electrode. According to the process illustrated in FIG. 5, the insulation material filled in the deep trench is fixed to the silicon substrate and passes through the interior of the electrode to support the electrode. Consequently, an insulation layer is not necessary on the side of the electrode. Therefore, electrodes having an “island” shape and separated from the silicon substrate on all sides can be formed. This process has the advantage that the metal layer is vapor-deposited on the electrode structure and the electrode structure is formed in a single release process. The metal layer can be formed without separate photolithography and etching processes. The process illustrated in FIG. 5, however, cannot be applied to a microstructure having high aspect ratio features.

### SUMMARY OF THE INVENTION

Accordingly, the present invention is directed to single-crystalline-silicon, single-wafer gyroscope fabricated using a new isolation method.

The new isolation method includes providing a microstructure comprising silicon, the microstructure having at least one released surface opposite and spaced from an underlying surface of a substrate comprising silicon. An insulation layer is formed over surfaces of the microstructure, including over the released surface, a conductive layer is formed over surfaces of the insulation layer, and a metal layer is formed over at least a top surface of the conductive layer on at least a portion of the microstructure.

Another preferred isolation method forms an insulation layer on the exposed surfaces of a microstructure after the microstructure has been formed by micromachining and released from the surface of an underlying substrate. The isolation method forms a conductive layer over the entire insulation layer and forms a metal layer over the conductive layer on top portions of the microstructure. Partially etching of the conductive layer forms electrical isolation between parts of the microstructure.

The conductive layer preferably may be a heavily-doped polycrystalline silicon layer having good step coverage formed by low pressure chemical vapor deposition (“LPCVD”). Etching of the conductive layer preferably may be accomplished by anisotropic dry etching. The insulation layer preferably may be a thermal oxide layer formed on the surface of a preferred single crystalline silicon by thermal oxidization. Alternatively, the insulation layer may be an oxide layer or a nitride layer formed by plasma enhanced chemical vapor deposition (“PECVD”) or LPCVD having good step coverage, or a composite insulation layer of a thermal oxide layer, an LPCVD oxide layer, an LPVCD nitride layer, a PECVD oxide layer and/or a PECVD nitride layer. Other insulators are apparent.

Another aspect of the invention provides a silicon microstructure having released structures and a layer structure for electrically isolating portions of the silicon microstructure. The layer structure comprises an insulation layer formed over released surfaces of the silicon microstructure, a conductive layer formed over the insulation layer including over sidewalls of the released structures, conductive layer having gaps electrically isolating portions of the silicon microstructure, and a metal layer formed over portions of the released structures.

An aspect for the present invention provides a micro-gyroscope comprising of oxide/polysilicon/metal triple layer for electrical isolation, in which the polysilicon layer is partially etched to accomplish the electrical isolation in the microstructure of the micro-gyroscope. The thickness of the layers also serve to compensate for the undercutting phenomenon inherent in deep silicon reactive ice etching (“RIE”), which can alter the stiffness characteristics.

An aspect of the present invention provides a micro-gyroscope fabricated by an isolation method which dose not require a separate photolithography process for isolation, there for can be applied to microstructures having high aspect ratios and narrow trenches.

An aspect of the present invention provides a micro-gyroscope comprising a new type of spring which has a node with a hole in the middle of spring to reduce the release etch time for spring.

### BRIEF DESCRIPTION OF THE DRAWINGS

Aspects and various advantages of the present invention are described below, with reference to the various views of the drawings, which form a part of this disclosure.

FIG. 1 illustrates a conventional SCREAM isolation process.

FIG. 2 illustrates a conventional isolation process employing a silicon on insulator (“SOI”) wafer.

FIG. 3 shows scanning electron microscope (“SEM”) photograph of a micromachined comb-drive structure employing a conventional junction isolation method.

FIG. 4 illustrates a conventional trench oxide isolation method.

FIG. 5 illustrates an isolation process employing a deep trench insulation layer.

FIGS. 6a-6d illustrate an isolation method used in the embodiment of the present invention.

FIGS. 7a-7b are SEM photographs of trench processed by the oxide/polysilicon/metal isolation method.

FIG. 8 is a schematic of composite beam.

FIG. 9 is a schematic of the designed micro-gyroscope.

FIG. 10 shows design example of the concatenated spring.

FIG. 11 shows simulated spring constant of the concatenated spring.

FIG. 12a-12e are SEM photographs of the fabrication process for the micro-gyroscope using the SBM process.

FIG. 13 shows a packaged and wired-bonded micro-gyroscope.

FIG. 14 shows an experimental setup for the performance test of the fabricated micro-gyroscope.

FIG. 15a-15b shows a model for parasitic capacitances.

FIG. 16 shows a frequency response of the fabricated micro-gyroscope to 10% sec, 11 Hz angular rate input.

FIG. 17 shows the measured and calculated bandwidth of the fabricated micro-gyroscope.

FIG. 18 shows the calculated bandwidth as a function of the frequency mismatch.

FIG. 19 shows the output versus angular-rate input

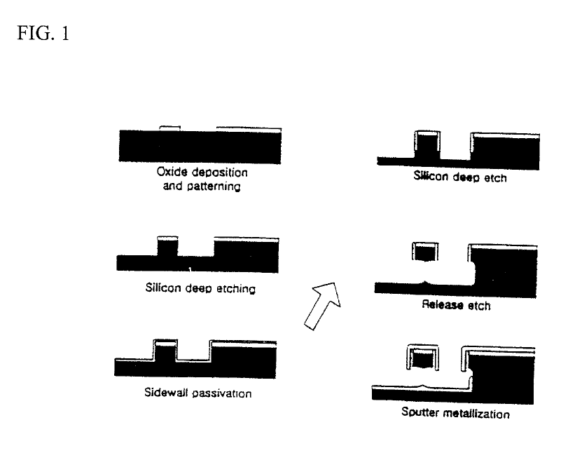

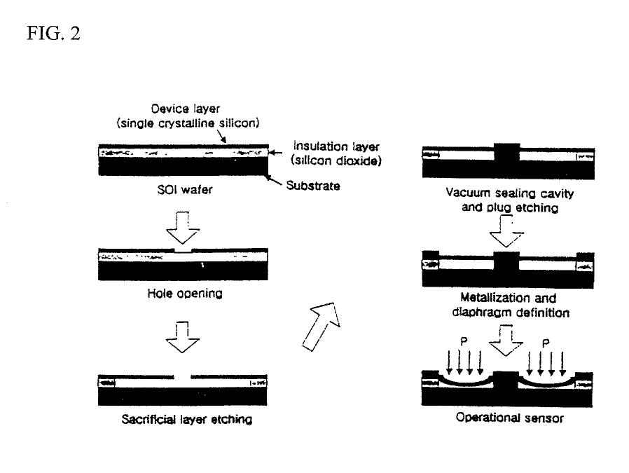

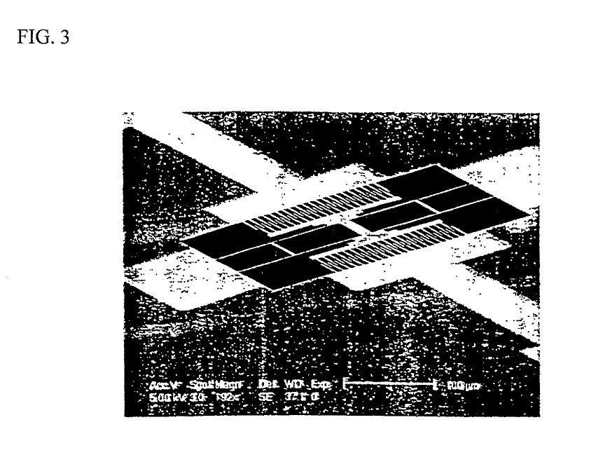

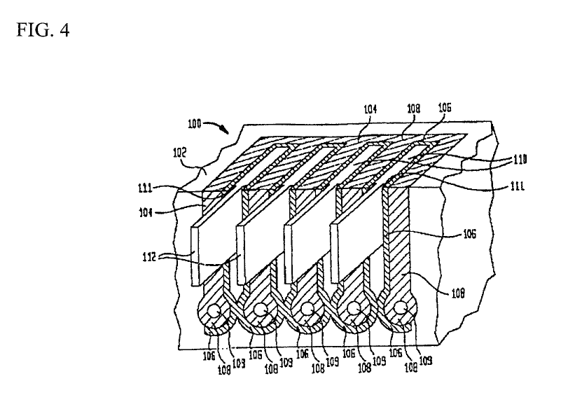

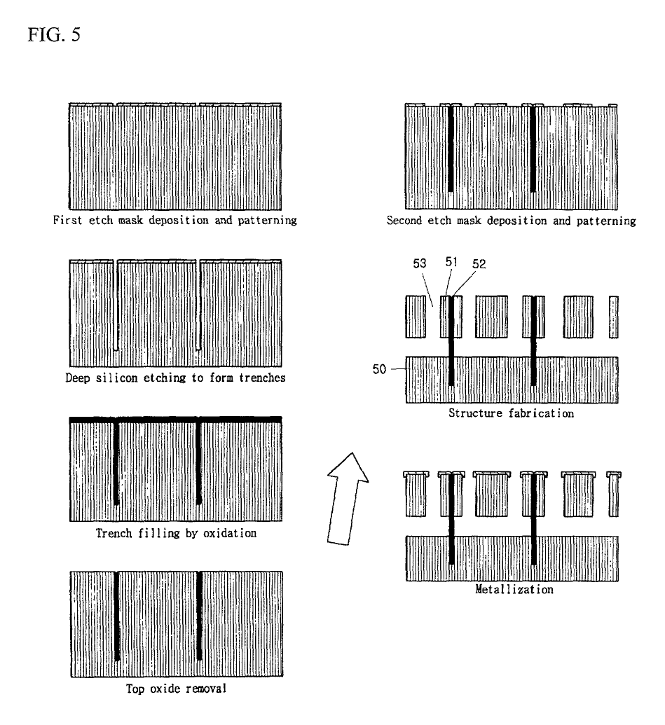

### DETAILED DESCRIPTION OF THE PREFERRED EMBODIMENT

In the Micro-gyroscope of the present invention, electrically isolation of the microstrustures, for example, driving spring and sensing spring, is accomplished by oxide/polysilicon/metal triple layer deposited in the microstructure. In the triple layer, the polysilicon layer is etched for electrically isolation after formation of oxide/polysilicon/metal triple layer or formation of oxide/polisilicon double layer. In the latter case, metal layer is deposited after the polysilicon layer etching.

In the following embodiment, the isolation method uses a heavily-doped LPCVD polysilicon film as the polysilicon layer, which can deposited in all sidewalls with an excellent step coverage, even in narrow-gap trenched. And the polisilicon layer is etched after the formation of the triple layers

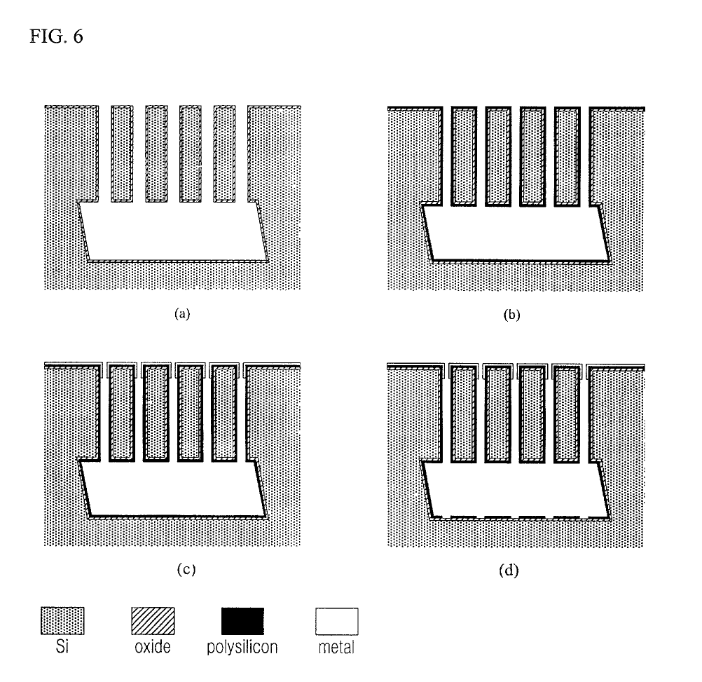

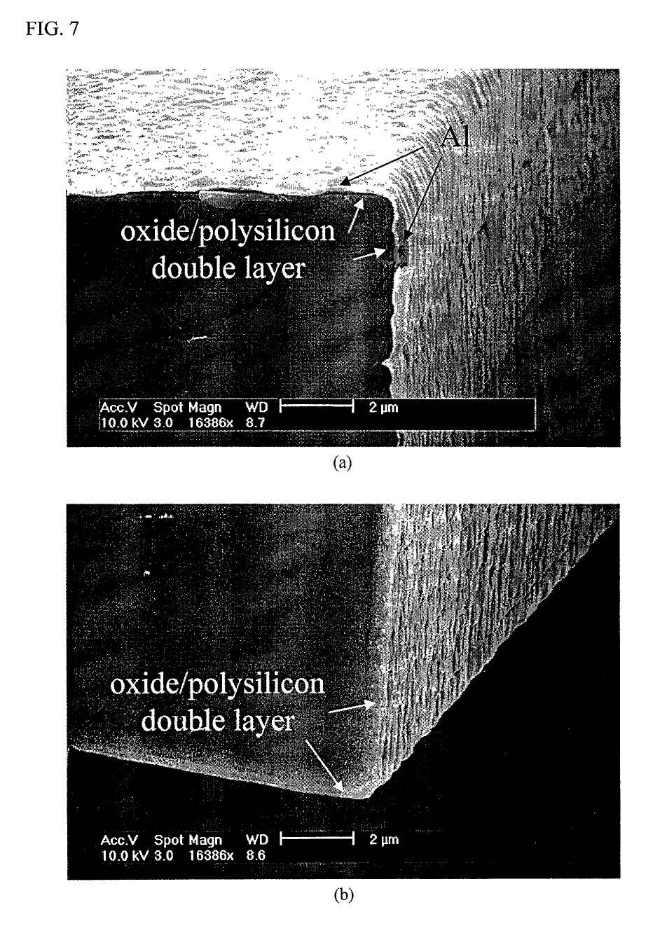

The detailed isolation process is shown in FIG. 6. In FIG. 6, it is assumed that the single-crystalline-silicon microstructure is already fabricated using a suitable process. This embodiment uses the SBM process. The isolation process starts with the oxidation of all exposed surfaces (FIG. 6a), followed by heavily-doped LPCVD polysilicon deposition (FIG. 6b). Since the LPCVD polysilicon films have an excellent step coverage, the polysilicon films are deposited at all sides of the released microstructure as well as at the top and bottom sides of the sacrificial gap as shown in FIG. 6b. Then, an Al film is sputtered or evaporated(FIG. 6c). For this step, equipment with poor step coverage is desired, since it is desired that the trench bottoms do not get deposited with Al. Polysilicon films at the exposed bottom areas are then selectively and anisotropically etched away, using an SF₆ and C₂F₈ based RIE process (FIG. 6d). The top Al layer serves as the etch mask, since SF₆ and C₂F₈ plasmas do not etch Al. The electrical isolation is obtained in this step. It is also possible to etch the polysilicon at the trench bottom before the deposition of Al. In this case, the Al films contact with polysilicon films only at the upper sidewalls of microstrutures.

FIG. 7 shows a fabrication example of oxide/polysilicon/metal triple layer isolation method, which is a cross section of a gyroscope fabricated in this embodiment. The thicknesses of the oxide, polysilicon, and metal films measured at the top side of wafer are 0.12□, 0.18□, and 0.35□, respectively. The trench depth is 40□, and the opening width is 8□. FIG. 7a shows the upper part of the trench. All the oxide, polysilicon and Al films are clearly visible at the top. On the sidewall, however, Al film is not deposited beyond several □ from the top. In FIG. 7b, which shows the lower part of the trench, the oxide and polysilicon films are uniformly deposited on both the sidewall and the bottom surface facing the substrate. No Al film is visible on any of the surfaces in this lower part. This allows utilizing the entire sidewall to maximize capacitance.

In this triple film isolation method, no additional photomask is necessary, and the entire process is very simple and short. Another notable advantage of this method is that trench gaps can be made smaller than the original dimensions defined by photolithography, because of the thickness of the additional films. This can be used to control the electrical capacitance, since it is proportional to the inverse of the gap distance.

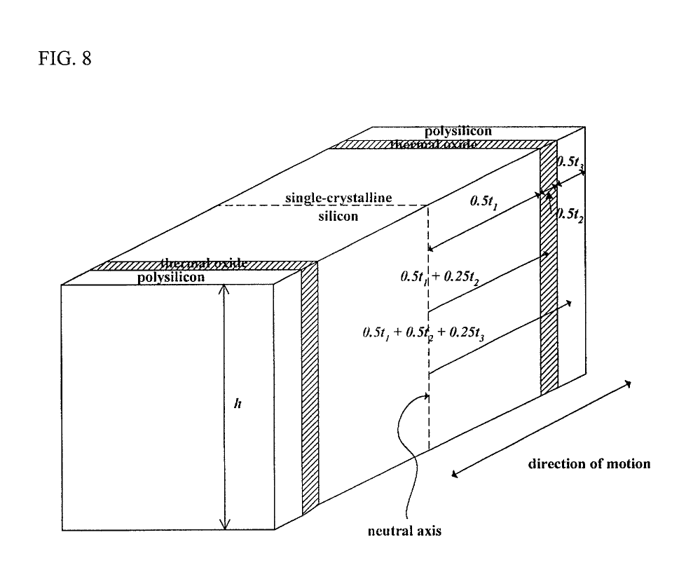

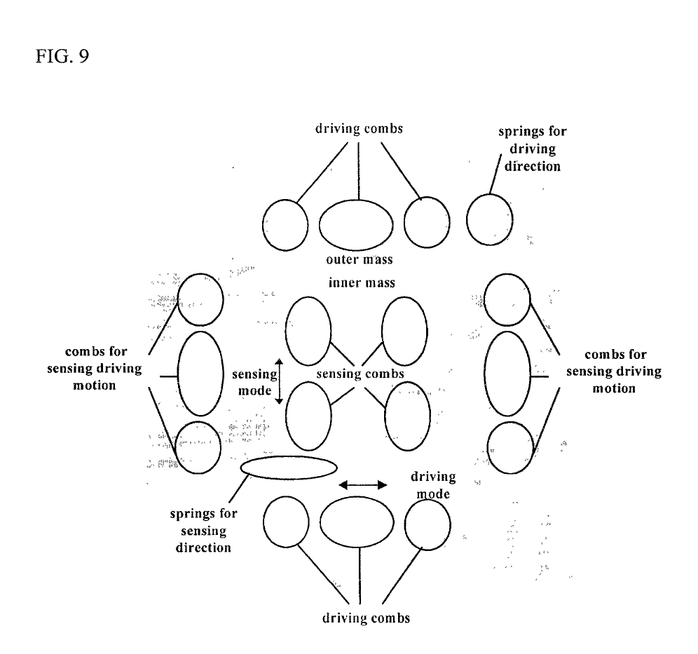

The most useful byproduct of this triple film isolation method is that the composite thickness can be adjusted to control and fine tune the device characteristics to match the original design specifications. This is, the undercut phenomenon inherent in deep silicon etchers can significantly alter the spring constant of beams, and the additional oxide and polysilicon films can be used to compensate for the undercut. Consider the cross section of a lateral spring shown in FIG. 8. The top metal film is neglected since it does not greatly change the spring constant.

To develop an expression to predict the value of resonant frequency as a function of deposited film thicknesses, it is assumed that the mass of deposited oxide and polysilicon films are negligible compared to the mass of the structural silicon, which is a reasonable assumption. Then, the value of resonant frequency is solely determined by the modified flexural rigidity,

$$\begin{matrix}{EI}_{total} = {E}_{1} {I}_{1} + {E}_{2} {I}_{2} + {E}_{3} {I}_{3} \\ = {E}_{1} \frac{{ht}_{1}^{3}}{12} + {E}_{2} ( \frac{{ht}_{2}^{3}}{48} + \frac{{{ht}_{2} ( 2 {t}_{1} + {t}_{2} )}^{2}}{16} ) + \\ {E}_{3} ( \frac{{h}_{3}^{3}}{48} + \frac{{{ht}_{3} ( 2 {t}_{1} + 2 {t}_{2} + {t}_{3} )}^{2}}{16} ) ,\end{matrix} \qquad ( 1 )$$

where E₁, E₂, and E₃ are the Young's modulus of silicon, oxide film, and polysilicon film, respectively, and I₁, I₂, and I₃ are the area moment of inertia of silicon, oxide film, and polysilicon film, respectively. The value of E₁ is 168.9 GPa. Note that Young's modulus is transversely isotropic on the (111) plane. It should also be noted that Young's modulus is not isotropic on either the (100) or (110) plane. The values of E₂ and E₃ can be obtained from the literature. From the equation (1), it is clear that a desired flexural rigidity can be obtained by adjusting the oxide thickness t₂ and the polysilicon thickness t₃. Note that since there are 2 parameters t₂ and t₃, the structural rigidity and the electrical capacitance can be independently controlled in certain ranges.

The micro-gyroscope fabricated in this embodiment, estimates the input angular velocity by sensing the displacement of a proof mass, induced by the Coriolis' force. FIG. 9 shows the schematic of the fabricated micro-gyroscope of the embodiment. The outer and inner masses are driven together in the x-direction at the driving mode resonant frequency. When an angular rate is applied in the z-direction, the inner mass moves in the y-direction. Note that there are different masses and different springs for the driving mode and the sensing mode. In a more conventional coupled-mode gyroscope with only one set of springs and one mass for driving and sensing, an induced Coriolis force makes the oscillation motion elliptical. This elliptical motion reduces the mechanical stability and becomes a source of a mechanical noise. The elliptical motion becomes more pronounced as the resonant frequency mismatch of the driving and sensing mode decreases. In this specification, gyroscopes with one set of suspensions are called “coupled” gyroscopes, and gyroscopes with separate sets of suspensions for the driving and sensing mode are called “decoupled” gyroscope. It is well known that the resolution of a coupled gyroscope is relatively lower than that of a decoupled gyroscope, because of the cross-axis coupling.

An example of micro-gyroscope is shown in FIG. 9. The driving and sensing mode resonant frequencies are designed to be 4.58 kHz and 5.76 kHz, respectively. In the composited beam analysis using (1), the undercut of 2500□, the oxide thickness of 1200 □, and the polysilicon thickness of 1800□ are considered. The resonant frequency of sensing mode is designed to be about 1200 Hz higher than that of driving mode, since the resonant frequency of sensing mode can be easily lowered with electrostatic tuning.

To design the decoupled gyroscope, two sets of springs for sensing and driving are necessary. These springs should be aligned with each other at a 90° angle. In (111) silicon wafer, if one spring is aligned parallel to the wafer flat, i.e., <110> direction, the other spring becomes aligned to the <111> direction. In the SBM process, the aqueous alkaline underetching is used to release the structures, and this underetching occurs at both ends of spring and propagates to the longitudinal direction when spring is aligned to the <111> direction. Since the underetching does not occur in the lateral direction in this case, the release etch time can become unnecessarily long. Although it is not critical, it is desirable to release all springs and comb fingers with similar conditions.

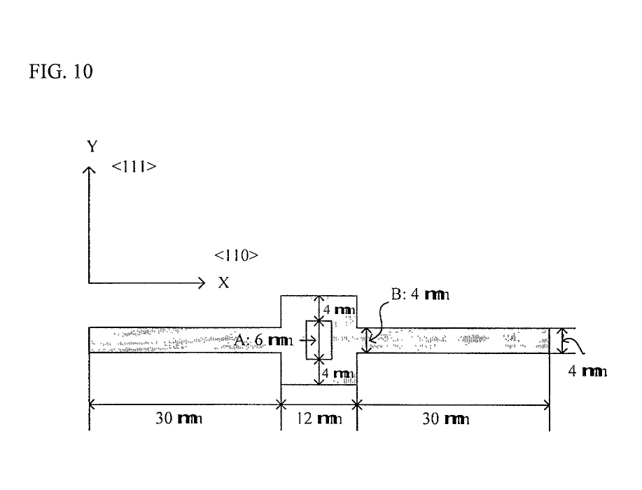

To reduce the release etch time for springs aligned to the <111> direction, a new type of spring is designed. As shown in FIG. 10, each spring has a node at the center of spring. The node has a hole in its center, thus the underetching can occur at the center of spring as well as at both ends of spring. For a proper release, the opening width of the hole in the node should be larger than the spring width. The spring with an arbitrary value of stiffness can be fabricated by concatenating this unit spring in series. A square node is shown, but a circular, hexagonal, or other shaped node can also be used.

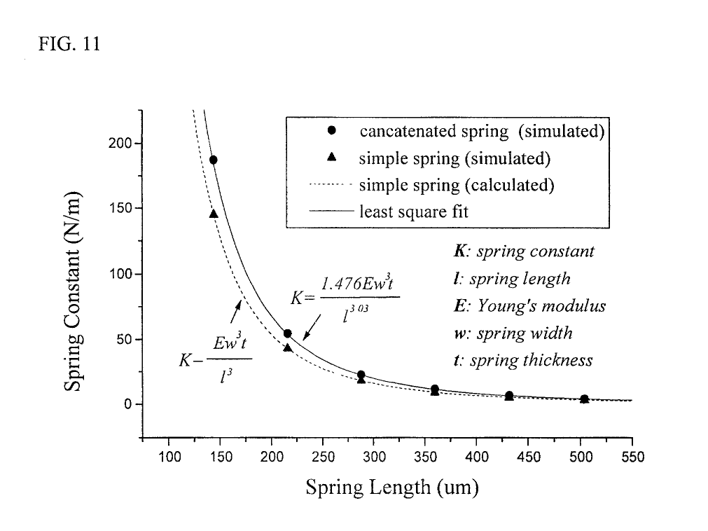

The spring constant of the concatenated spring is calculated using a commercial software, ANSYS. FIG. 11 summarizes the simulation results. In the simulation of concatenated spring, the unit spring of FIG. 10 is assumed. The spring constant of the concatenated spring is slightly larger than that of the simple spring for the same spring length and width. The spring width of 4□, thickness of 40□, and concatenation at every 72□ are assumed for both cases.

In this embodiment, a single-crystalline-silicon micro-gyroscope is fabricated in a single wafer using the SBM process and the oxide/polysilicon/metal triple layer isolation method. The structural thickness of fabricated micro-gyroscope is 40□, and the sacrificial gap is 50□. The chip size is 2.2□×3□. Only a single mask is required to fabricate the micro-gyroscope. The large sacrificial gap of 50□ is beneficial in terms of reducing air damping, and thus, increasing the Q-factor.

The fabrication process starts with an n-type, (111)-oriented silicon wafer with a resistivity of 10 mΩ. A plasma-enhanced chemical vapor deposition (PECVD) oxide layer is deposited and patterned. The deposited oxide layer is used as a hard mask for deep silicon etching. Next, a vertical, deep silicon RIE is performed to a depth of 40□ to define the structural patterns. The first oxide layer should be thick enough to withstand the vertical silicon RIE steps for structure patterning and sacrificial-gap definition, as well as the final aqueous alkaline etching for releasing the structures. In the standard Bosch process, the etch depth is highly dependent on the opening width. Thus, it is important to design all opening width to be about the same in order to have a uniform etch depth. In our design, the minimum opening width is 2□ and the maximum is 15□. The maximum opening width is the required dimension for resonating the structure. The final structure thickness becomes the etch depth at the smaller openings.

After the structure patterning step, a 1200□-thick thermal oxide film is grown. The film is used to protect the structure sidewalls in alkaline etching. This oxide film is then anisotropically etched using RIE to expose bare silicon at the bottom of the etched patterns. This step should not etch the oxide on sidewalls and should not expose bare silicon at the top. Then, the silicon wafer is vertically etched again using deep silicon RIE. The etch depth at the larger opening measured from the first etch depth at the smaller opening is 50□. This results in a sacrificial gap of 50□. The wafer is then dipped into a 20%, 90□ tetramethyl ammonium hydroxides (TMAH) solution for 15 minutes, to perform the release etch. In this step, the lower parts of the sidewalls without the oxide passivation will be etched in the lateral direction. The etch rate in <110> directions is about 95□/hr in this etch condition. After the release etch step, all sidewall passivation oxide and top oxide films are removed in an HF solution.

After that, the oxide/polysilicon/metal triple layer isolation process is performed. For isolation, a 1200□-thick thermal oxide film is grown. Next, an LPCVD polysilicon film is deposited to a thickness of 1800□. Note that the undercut in our deep etch process is about 2500□. The deposition temperature is 585□, and the as-deposited residual stress is 30 MPa in a tensile state. For doping of polysilicon films, the predeposition of phosphorus-containing oxide is performed at the atmospheric pressure and 900□ for 10 minutes, with 2000 sccm of N₂, 400 sccm of POCl₃-containing N₂, and 200 sccm of O₂. Then, a 3500□-thick, 1% silicon-containing Al film is sputtered at the top. This Al film is used for the electrodes, and also serves as the hard mask for the ensuing polysilicon anisotropic etch to remove the lines and areas of polysilicon at the bottom for electrical isolation.

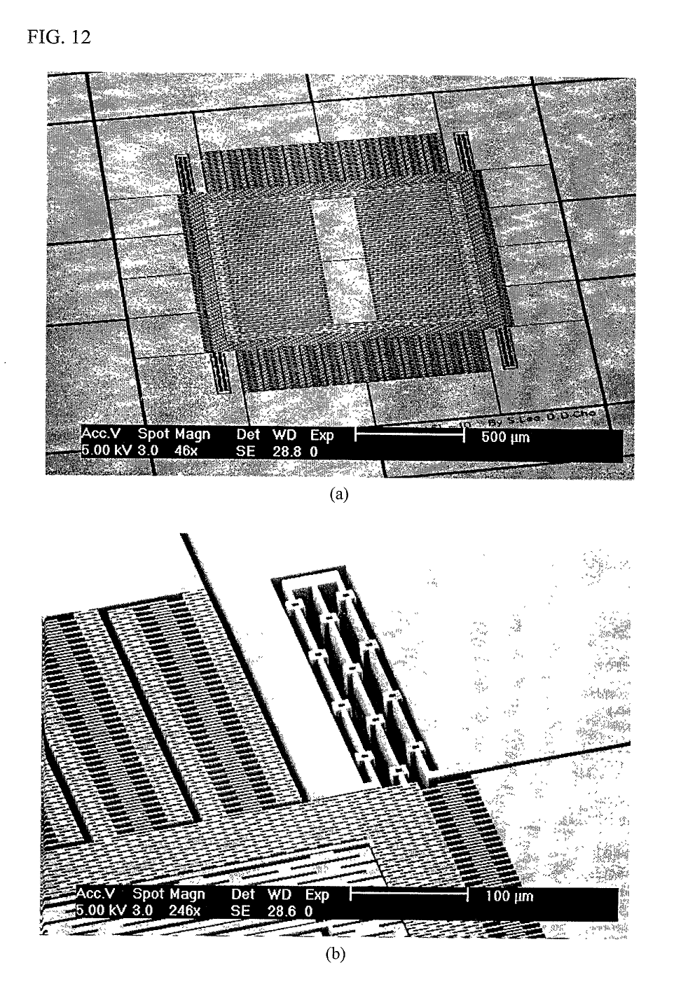

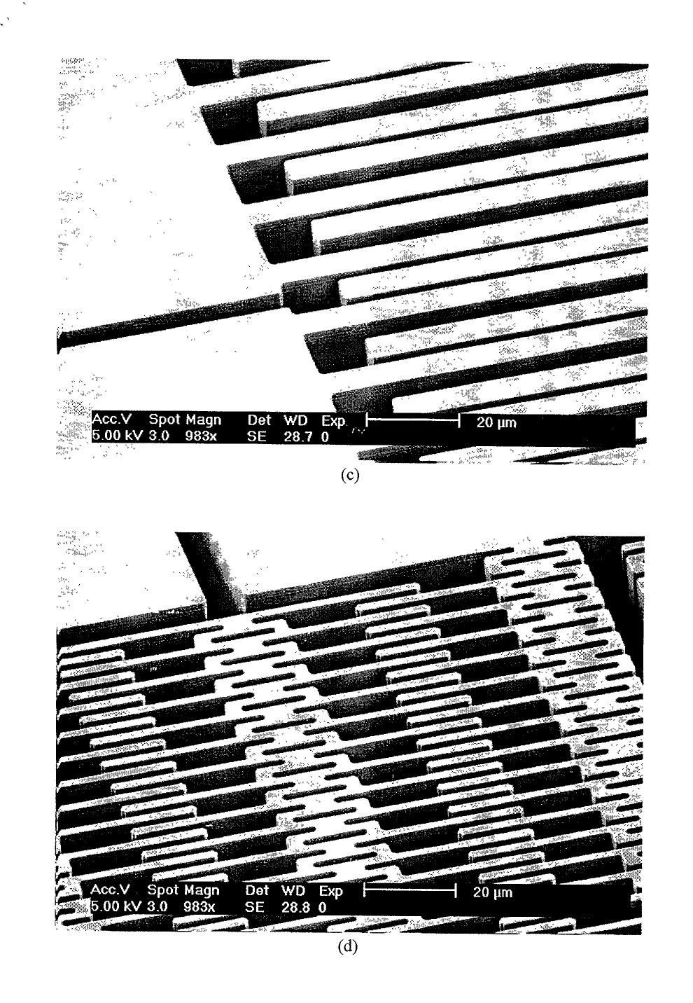

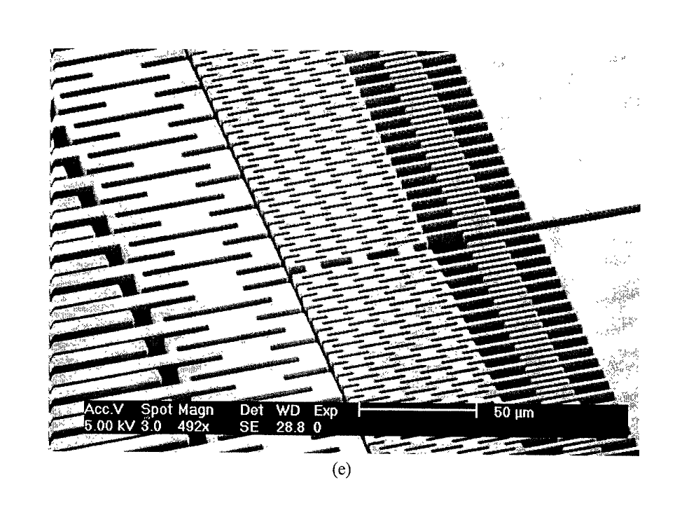

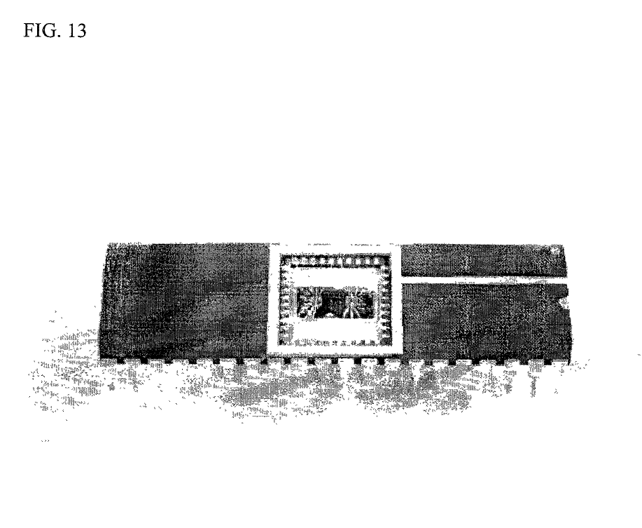

FIG. 12a shows SEM photographs of the released micro-gyroscope. FIG. 12b shows the concatenated springs. FIGS. 12c, 12d, and 12e show the combs for sensing Coriolis' force, the combs to drive the mass, and the combs for sensing the driving motion, respectively. FIG. 13 shows a packaged and wire-bonded micro-gyroscope.

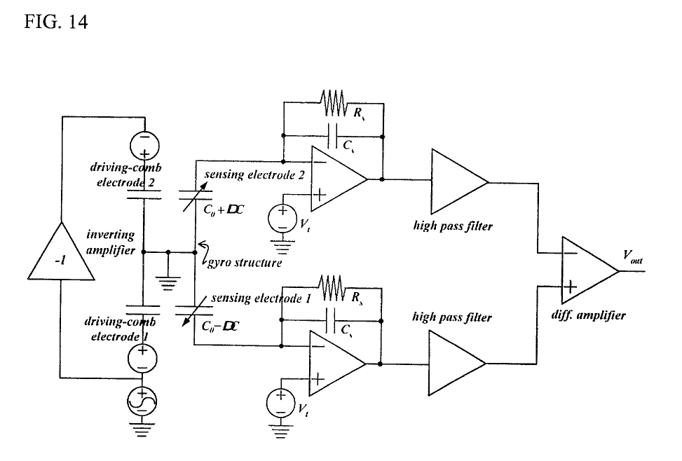

The performance of the fabricated micro-gyroscope is experimentally evaluated. FIG. 14 shows the measurement scheme. In the testing, the feedback control for generating self-oscillation of driving mode is not used. However, the combs for sensing driving mode can monitor the displacement induced by the driving-mode vibration. To vibrate the gyroscope, a 2.5 volt peak-to-peak sinusoidal voltage with a 0.8 volt offset is applied to the driving-comb electrode 1. The driving-comb electrode 2 is oppositely placed to the driving-comb electrode 1. To the driving-comb electrode 2, an anti-phase sinusoidal voltage with the same offset is applied.

In the prepered embodiment, the moving parts of the micro-gyroscope are connected to ground. Thus, if the moving parts have a zero resistance, there is no electrical signal in the moving parts. However, in reality, the resistance of the moving parts, measured from one end of spring support to the other end, ranges from several tens of ohms to several hundreds of ohms. Therefore, an electrical signal with the same frequency but a slightly different phase to the driving signal is induced in the moving parts. This induced signal becomes a source of noise. The anti-phase driving scheme cancels out this electrical signal because signal induced by the anti-phased driving signal has an 180° phase difference to each other. Moreover, this scheme cancels out electrical signal induced by the parasitic capacitance between the driving and sensing electrodes.

To sense the displacement induced by Coriolis force, the sensing electrodes are connected to the negative input of the two charge amplifiers. The moving parts and the substrate are grounded. The tuning voltage V_{T} is applied to the positive input terminals of the charge amplifiers. This tuning voltage is used to control the resonant frequency of the sensing mode. In this setup, the dc voltage of V_{T} appears at the output of the charge amplifier. To remove the dc voltage, a high-pass filter is used. The modulated output voltage is obtained by subtracting the two output signals of the high pass filters. Finally, the angular rate is obtained by demodulating the output signal.

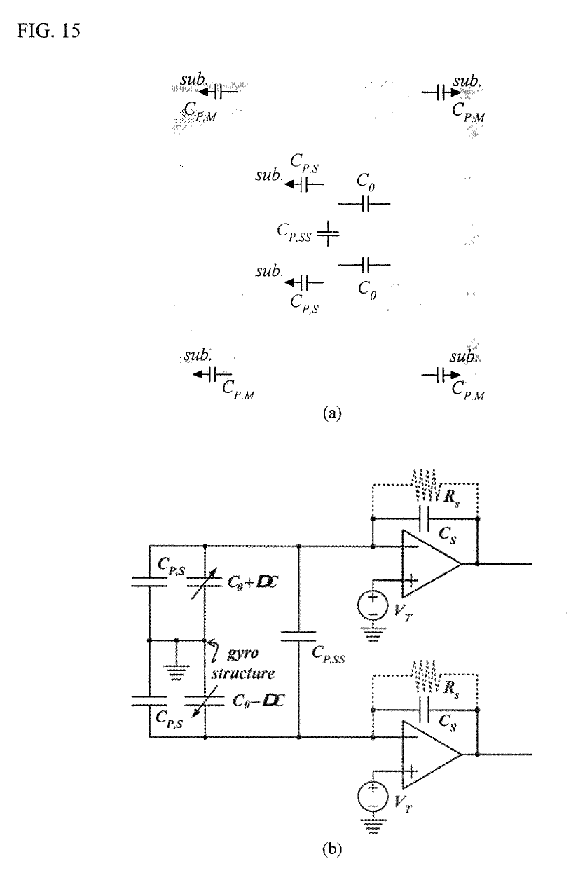

The effect of the parasitic capacitances is analyzed. FIG. 15 shows possible configurations of parasitic capacitance and an equivalent circuit representation. In FIG. 15a, C_{p, ss} is the capacitance between the two stationary sensing electrodes. It is calculated to be 14.17 fF for the structural thickness of 40□. The capacitance between the sensing electrode and the substrate Cₚₛ is calculated to be 41 pF for the insulating oxide thickness of 0.12□. The capacitance between the movable structure and the substrate C_{P,M} is calculated to be 107.5 pF for the insulating oxide thickness of 0.12□. The values are calculated using the parallel-plate approximation. In the calculations, it is assumed that the surfaces of substrate facing the sensing electrodes or facing the electrodes connected to the movable structure are in an accumulation state. This assumption is very reasonable because the surface is highly doped with phosphorus and the operation voltage is in the range of several volts. In the equivalent circuit model, C_{P,M} disappears since the substrate and the movable structure are grounded together. The C_{P,SS} also disappears since the two terminals of C_{P,SS} are connected to the negative input terminals of the charge amplifiers, where constant voltage of V_{T} is maintained by the virtual ground effect. The C_{P,S} can affect the output of the charge amplifiers. However, if the value of C_{P,S} does not change, the effect is none. To keep C_{P,S} constant, a highly doped silicon wafer is used and thus, the surface of the substrate is always in an accumulation state.

To enhance resolution, it is necessary to make the difference in the resonant frequencies of the sensing and driving modes small. Typically, the frequency mismatch should be on the order of 10 Hz. This tight specification requires accurately characterizing the resonant frequencies. The measured resonant frequency of the driving mode is 4.61 kHz, which is slightly higher than the analytic result of 4.58 kHz. The sensing mode resonant frequency can be adjusted by changing the tuning voltage V_{T}. For V_{T} of 2.5 volts, the resonant frequency is measured to be 5.73 kHz, and for V_{T} of 5.65 volts, the resonant frequency is measured to be approximately 4.60 kHz, which is separated from the driving mode by approximately 10 Hz. It is estimated that the resonant frequency of the sensing mode with no tuning voltage is approximately 5.80 kHz, which is again only slightly higher than the analytic result of 5.76 kHz.

The fabricated micro-gyroscope is tested in a 10 mTorr vacuum chamber, which is installed on a rate table. The output of the sensing circuit shown in FIG. 14 is connected to a spectrum analyzer. In the test, the sensing mode resonant frequency is tuned to be 11 Hz higher than the driving mode frequency of 4.61 kHz.

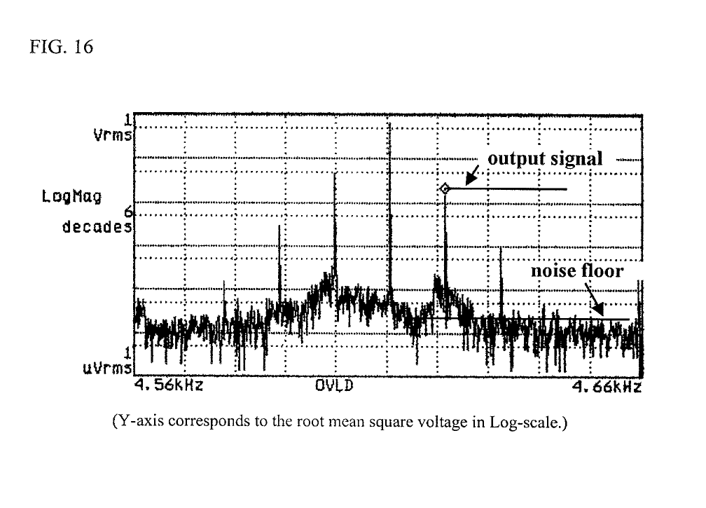

FIG. 16 shows the output of the spectrum analyzer when a 10% sec, 11 Hz angular rate is applied to the micro-gyroscope. In FIG. 16, the peak with the largest amplitude is the driving signal at 4.61 kHz, which appears due to the parasitic capacitance between bonding wires. The second largest peak corresponds to the 11 Hz angular-rate input, which is separate from the driving signal by 11 Hz. The third and last peak is separated from the driving signal by 22 Hz. The first peak at 4.61 kHz can easily be eliminated by the synchronous demodulation circuit, since this peak has a phase difference of about 90° with respect to the output signal. The third peak at 4.632 kHz is caused by the pumping line connected to the chamber, where the micro-gyroscope is placed for testing. The pumping line between the chamber and vacuum pump experiences a centrifugal force, which has a frequency twice the rotational frequency of the rate table. This centrifugal force, in turn, imposes a mechanical coupling noise to the chamber. The third peak does not appear if the pumping line is disconnected. In FIG. 16, the amplitude of the second peak at 4.621 kHz is 1,000 times larger than the indicated noise floor, which gives a noise-equivalent angular-rate resolution of 0.01% sec.

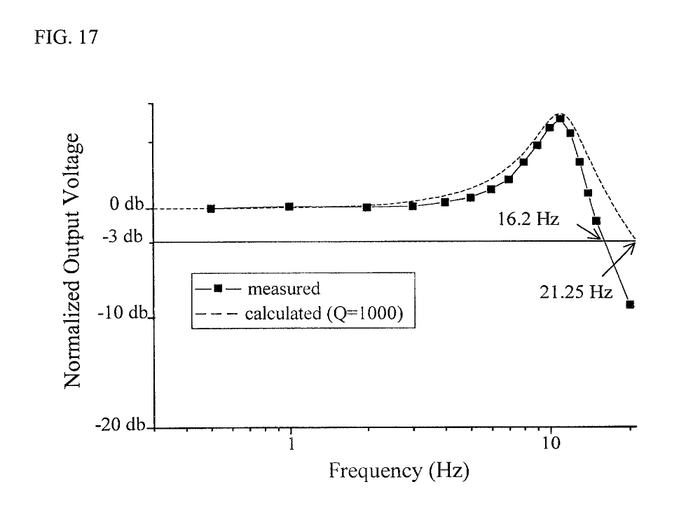

An important measure of gyroscope performance is bandwidth, which is not uniquely determined by its own parameters. The bandwidth is also dependent on the frequency mismatch and the ambient vacuum level. The frequency response of the fabricated micro-gyroscope is shown in FIG. 17. The measured bandwidth is 16.2 Hz. The calculated frequency response as shown in FIG. 17 is obtained, for Q₂ of 1,000.

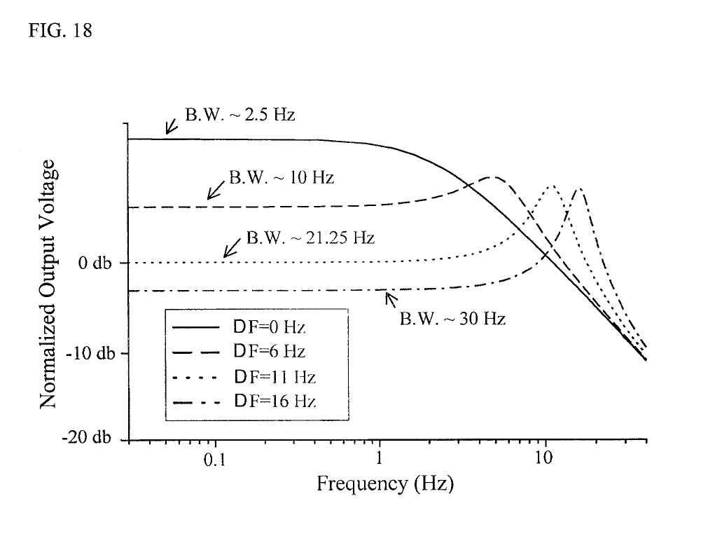

The bandwidth is a function of the driving and sensing mode frequency mismatch as shown in FIG. 18. As the frequency mismatch is increased, the bandwidth increases. The trade-off in design is that the resolution becomes poor as this frequency mismatch is increased.

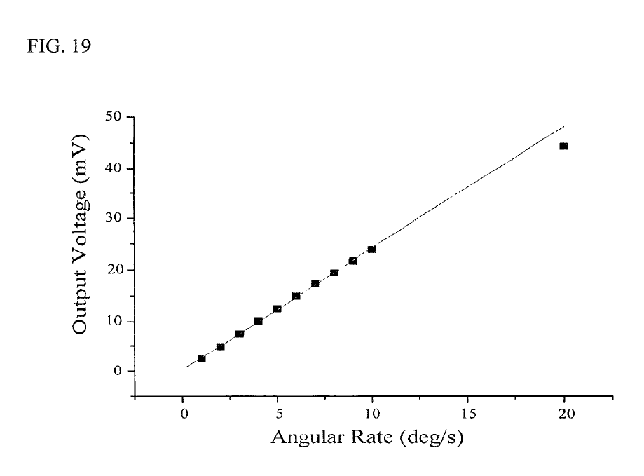

FIG. 19 shows the measured output as a function of angular rate. The frequency of the angular rate is fixed at 11 Hz and the amplitude of the angular rate is varied from 1% sec to 20% sec.

What is claimed is:

1. A micromachined single-crystalline silicon micro-gyroscope, comprising of oxide/polysilicon/metal triple layer for electrical isolation, in which polysilicon layer is partially etched to accomplish the electrical isolation in the microstructure of the micro-gyroscope.

2. The micro-gyroscope of claim 1, wherein the deposition depths of the oxide layer and the polisilicon layer are adjusted to determine the width of the spring and spring constant, thereby adjusting the resonant frequency of the micro-gyroscope.

3. The micro-gyroscope of claim 1, wherein the micro-gyroscope is the decoupled type, in which a driving electrode and a sensing electrode are electrically isolated by the said oxide/polisilicon/metal triple layer.

4. The micro-gyroscope of claim 3, wherein the driving spring and the sensing spring are aligned with each other at a 90° angle.

5. The micro-gyroscope of claim 4, wherein the driving springs and sensing springs have a node with a hole in the middle.

6. The micro-gyroscope of claim 5, wherein the opening width of the each hole is larger than the width of the spring.

7. The micro-gyroscope of claim 3, wherein the vertical depth of both of the driving electrode and the sensing electrode is larger than 10□.

8. The micro-gyroscope of claim 7, which is fabricated by SBM process in which the depth of a sacrificial layer is larger than 10□.

9. The micro-gyroscope of claim 3, wherein a DC biased voltage as tuning voltage is applied to either the driving spring or the sensing spring to control the stiffness of the spring.

10. The micro-gyroscope of claim 9, the tuning voltage is applied to the sensing spring.

11. The micro-gyroscope of claim 10, wherein the moving microstructure of the micro-gyroscope and silicon substrate is grounded and sensing spring is connected to a negative input of two charge amplifiers.

12. The micro-gyroscope of claim 11, wherein the tuning voltage is applied to the positive input terminals of the charge amplifiers, and angular rate is obtained by demodulating the output signal of a high pass filter to remove the tuning voltage.
